(19) United States
(12) Patent Application Publication
(10) Pub. No.: US 2009/0145061 A1
(43) Pub. Date: Jun. 11, 2009

(54) SNAP-FIT ELEVATOR HOISTWAY ENTRANCE

(76) Inventors: Ashok Kalhan, Bloomington, IN (US); Suresh Dharmaraj, Bloomington, IN (US)

Correspondence Address: CARLSON GASKEY & OLDS, 400 W MAPLE STE 350, BIRMINGHAM, MI, 48009, US

(21) Appl. No.: 11/719,308

(22) PCT Filed: Jan. 6, 2005
(86) PCT No.: PCT/US05/00820

§ 371 Date: Feb. 17, 2009

(51) Int. Cl. B66B 13/30; E06B 1/04

(52) U.S. Cl. 52/204.1; 52/745.16

(57) ABSTRACT

An elevator hoistway entrance (20) invention includes a snap-fit connection (38) that secures a first hoistway entrance member (32, 40) to a second hoistway entrance member (34, 42) in a desired structural relation. In disclosed embodiments, the snap-fit connection (38) includes at least one receiver (56) and at least one securing member (44) that is at least partially received in the receiver (56) in a first position and is moveable into a second position to secure the first hoistway entrance member (32, 40) to the second hoistway entrance member (34, 42). The securing member (44) is moved in a first direction (66) into an insertion portion (60) of the receiver (56) and then moved into a securing portion (62) to secure the first hoistway entrance member (40) to the second hoistway entrance member (42). A locking member (72) is then inserted through respective openings (64) in the first hoistway entrance member (40) and the second hoistway entrance member (42) to further prevent the securing member (44) from moving from the securing portion (62).

### FIELD OF THE INVENTION

This invention generally relates to elevator systems. More particularly, this invention relates to elevator doorway entrances.

### BACKGROUND OF THE INVENTION

Elevator systems are widely known and used. Typical arrangements include an elevator cab that moves in a hoistway between building levels to transport passengers or cargo. A landing at each building level includes a hoistway entrance which supports hoistway entrance doors that open and close simultaneously with elevator cab doors when the elevator cab is stopped at the building level.

An installer typically constructs the hoistway entrances from sills, jambs, brackets, or other hoistway entrance components. The hoistway entrance components are secured to one another using nuts and bolts. The nuts and bolts typically do not provide a precise connection between the hoistway entrance components and installation of the nuts and bolts is time consuming and laborious.

There is a need for a simplified elevator hoistway entrance and method for assembling such an elevator hoistway entrance. This invention addresses those needs while avoiding the shortcomings and drawbacks of the prior art.

### SUMMARY OF THE INVENTION

An exemplary elevator hoistway entrance assembly includes a snap-fit connection that secures a first hoistway entrance member to a second hoistway entrance member in a desired structural relation.

One example snap-fit connection includes at least one receiver and at least one securing member that is at least partially received in the receiver in a first position and is moveable into a second position to secure the first hoistway entrance member to the second hoistway entrance member. The securing member moves in a first direction into an insertion position and then moves in a second direction into a secured position to secure the first hoistway entrance member to the second hoistway entrance member.

In one example, a locking member is inserted through respective openings in the first hoistway entrance member and the second hoistway entrance member to lock the securing member in the secured position.

Another example snap-fit connection includes a bracket positioned between a jamb and a sill. The bracket includes securing members that are received into respective receivers located on the jamb and sill and moved into a locking position to secure the jamb to the sill.

The various features and advantages of this invention will become apparent to those skilled in the art from the following detailed description of the currently preferred embodiments. The drawings that accompany the detailed description can be briefly described as follows.

### BRIEF DESCRIPTION OF THE DRAWINGS

FIG. 1 illustrates a perspective view of selected portions of an example elevator system and hoistway entrance.

FIG. 2 illustrates a perspective view of an example hoistway entrance.

FIG. 3 illustrates one example snap-fit connection.

FIG. 4 illustrates the example of FIG. 3 in a secured position.

FIG. 5 illustrates another example of a snap-fit connection that includes a bracket positioned between a jamb and a sill.

FIG. 6 illustrates the snap-fit connection of FIG. 5 in a secured position.

FIG. 7 illustrates a perspective view of an example of hoistway entrance member,

FIG. 8 illustrates the hoistway entrance member of FIG. 7 in a locked position.

### DETAILED DESCRIPTION OF THE PREFERRED EMBODIMENTS

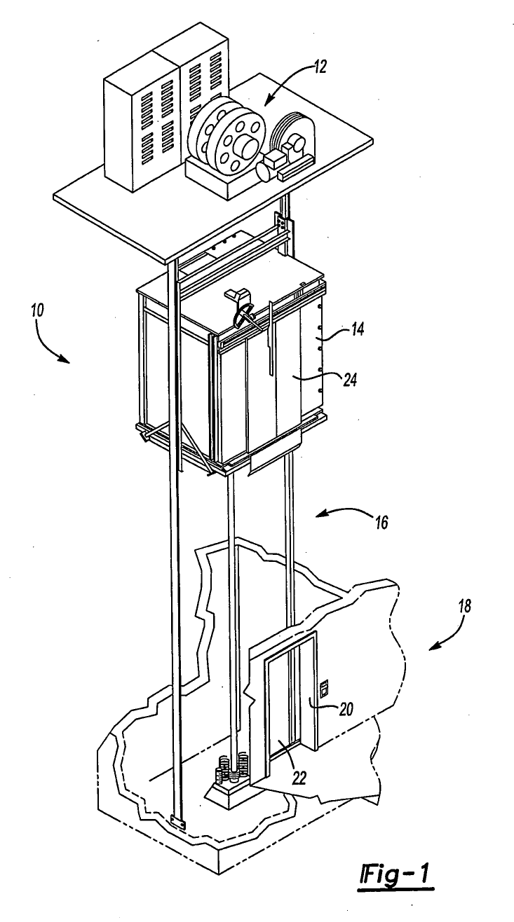

FIG. 1 illustrates a perspective view of an example elevator system 10 that includes an elevator machine system 12 positioned above an elevator cab 14. The elevator machine system 12 moves the elevator cab 14 in an elevator hoistway 16 as known between building levels. Passengers access the elevator cab 14 through a hoistway entrance 20 located at the building level is, for example. The illustrated hoistway entrance 20 includes a set of hoistway doors 22 that open and close in concert with elevator cab doors 24 as known to provide access to the elevator cab 14.

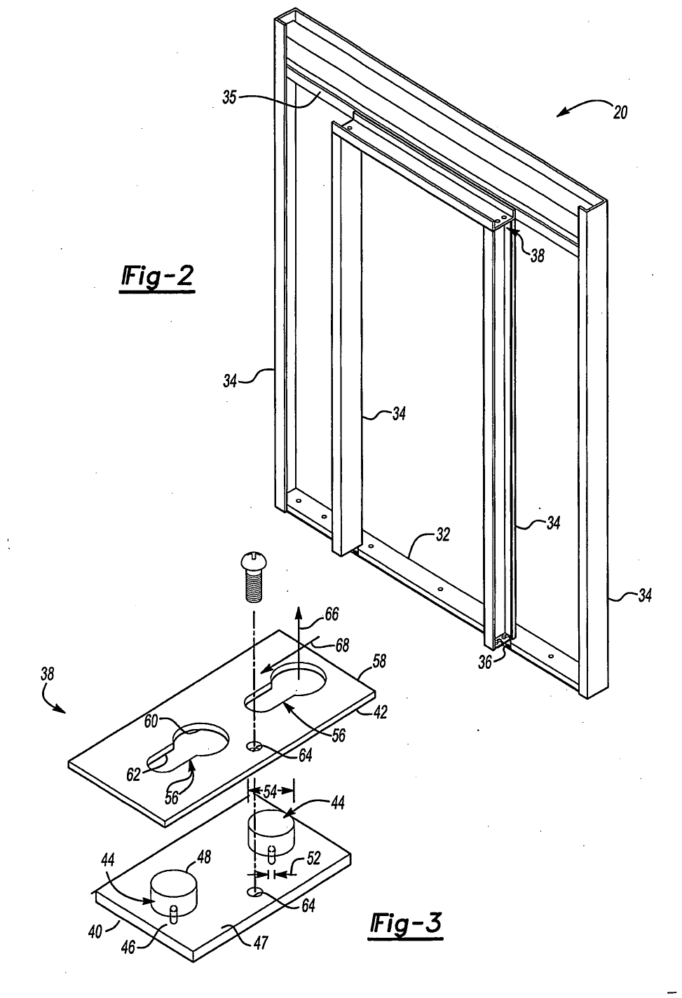

FIG. 2 illustrates a perspective view of the example hoistway entrance 20 comprising a plurality of hoistway entrance members. The hoistway entrance 20 includes a sill 32, jambs 34, a header 35 and brackets 36 secured together by snap-fit connections 38. The term “snap-fit” as used in this description refers to a type of connection and method of making the connection that does not necessarily exhibit a “snapping” sound when making the connection.

FIG. 3 illustrates one example snap-fit connection 38 in more detail. The snap-fit connection 38 secures a first hoistway entrance member 40, which may be part of the sill 32 for example, to a second hoistway entrance member 42, which may be part of a jamb 34. The first hoistway entrance member 40 includes two securing members 44. In one example, the securing members 44 include a shaft 46 that extends from a surface 47 of the first hoistway entrance member 40 and a head 48 that is supported on a distal end 50 of the shaft 46. The example shaft 46 includes a circular cross section and a nominal diameter 52 and the head 48 has a circular cross section and a larger diameter 54.

The second hoistway entrance member 42 includes receivers 56. The illustrated receivers 56 have a closed periphery. Another example receiver comprises a slot that is open at one end. The receivers 56 each include an insertion portion 60 having a dimension that corresponds to the larger diameter 54 of the heads 48 and a securing portion 62 having a dimension that corresponds to the nominal diameter 52 of the shafts 46. The receiving portion 60 and securing portion 62 respectively receive and secure the securing members 44 of the first hoistway entrance member 40. In one example, each of the first hoistway entrance member 40 and the second hoistway entrance member 42 also include respective openings 64 that align when the securing members 44 are positioned in the securing portions 62.

The height or length of the shaft 46 in one example is approximately equal to the thickness of the material adjacent the securing portion 62 to provide a snug fit.

In the illustrated example, the securing members 44 are moved in a first direction 66 into the insertion portion 60 of the receivers 56. The securing members 44 are then moved in a second direction 68 from the insertion portion 60 to the securing portion 62 to secure the first hoistway entrance member 40 to the second hoistway entrance member 42 in a desired structural relationship.

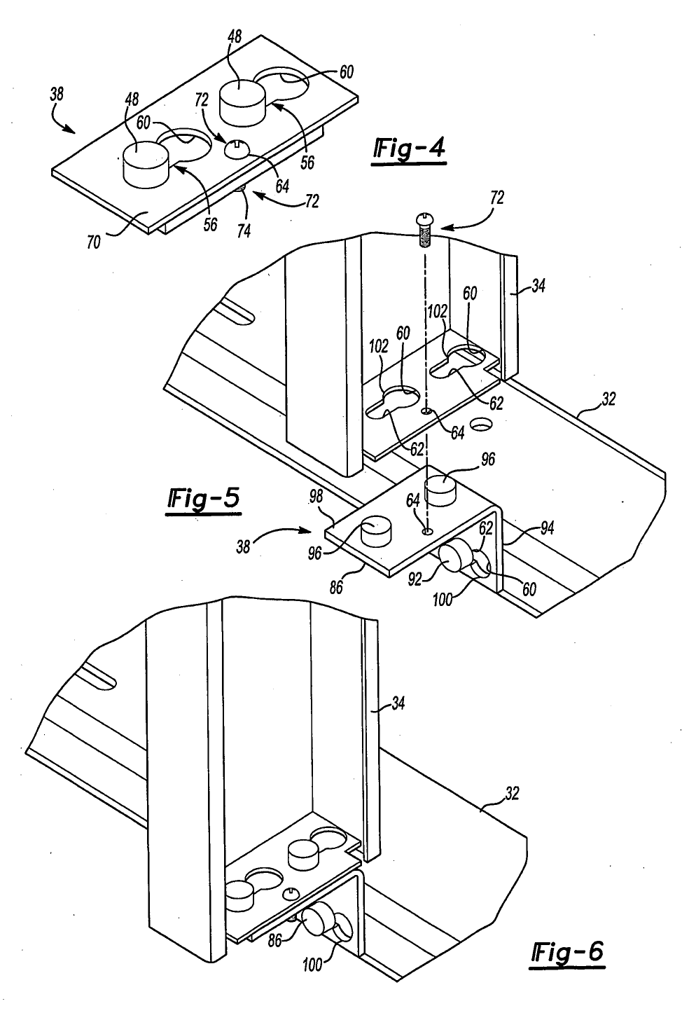

FIG. 4 illustrates an example secured position wherein the heads 48 of the securing members 44 engage a surface 70 of the second hoistway entrance member 42 adjacent to the receivers 56. This position secures the entrance members together and prevents relative movement in two directions.

A locking member 72 such as a pin, rod or bolt, is then inserted through the respective openings 64 to prevent relative movement in a third, different direction. The locking member 72 cooperates with the securing members 44 to lock the first hoistway entrance member 40 and the second hoistway entrance member 42 in the desired structural relationship. Once the locking member 72 is in place, the securing members 42 are locked into the secured position. In one example, the locking member 72 includes a textured surface that engages the respective openings 64 and secures the locking member 72 in the respective openings 64.

FIG. 5 illustrates another example of a snap-fit connection 38 that includes a bracket 86 positioned between a jamb 34 and a sill 32. The bracket 86 includes securing members 92 (only one is shown) located on a first surface 94 of the bracket 86 and second securing members 96 located on a second surface 98 of the bracket 86. The sill 32 includes first receivers 100 for receiving the securing members 92. The first receivers 100 include an insertion portion 60 and a securing portion 62. The jamb 34 includes second receivers 102 including insertion portions 60 and securing portions 62 for respectively receiving and securing the second locking members 96 on the bracket 86 as illustrated in FIG. 6.

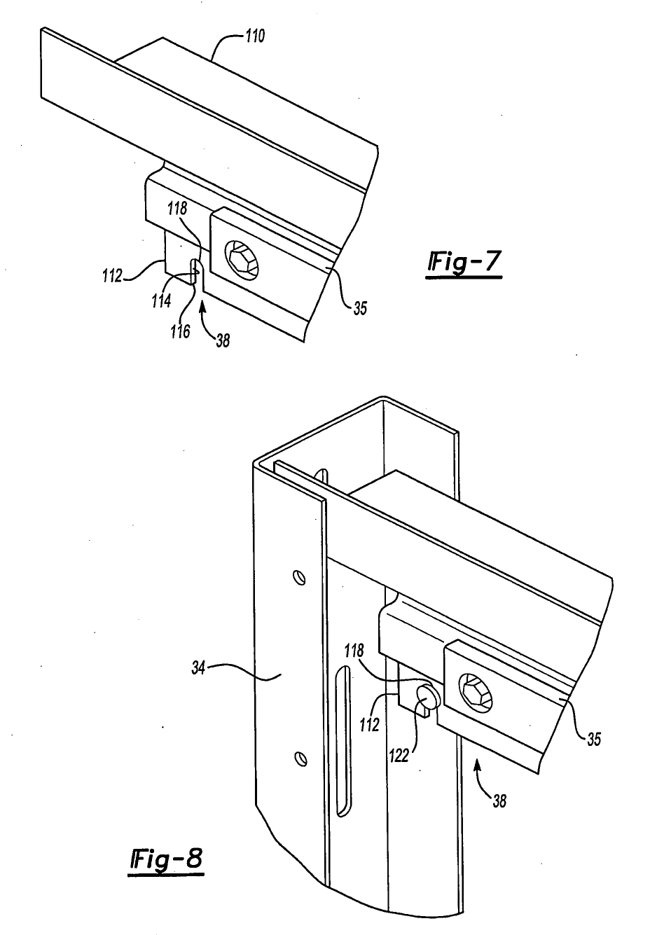

FIG. 7 illustrates a perspective view of another example snap-fit connection 38. The snap-fit connection in this example secures a header member 35 having a surface 112 that includes a slot receiver 114 that is open at one end 116. An opposite end 118 of the receiver 114 rests upon a securing member 122 on a jamb 34 as shown in FIG. 8.

A combination of such snap fit connections can be used to assemble an entire hoistway entrance. The disclosed example may provide the advantage of allowing assembly of an entrance without requiring any tools. A tool may be useful or necessary to place some example locking members 72 into position.

Although a preferred embodiment of this invention has been disclosed, a worker of ordinary skill in this art would recognize that certain modifications would come within the scope of this invention. For that reason, the following claims should be studied to determine the true scope and content of this invention.

1. An elevator hoistway entrance assembly comprising:
a snap-fit connection that secures a first hoistway entrance member to a second hoistway entrance member in a desired structural relationship.

2. The assembly as recited in Claim l, wherein the snap-fit connection comprises at least one receiver and at least one securing member that is at least partially received in the receiver in a first position and is moveable into a second position to secure the first hoistway entrance member to the second hoistway entrance member.

3. The assembly as recited in claim 2, wherein the receiver comprises an opening through a surface of the first hoistway entrance member.

4. The assembly as recited in claim 2, wherein a direction of insertion corresponding to moving the securing member into the first position is different than a direction of moving the securing member into the second position.

5. The assembly as recited in claim 2, wherein the first hoistway entrance member and the second hoistway entrance member include respective openings that align when the securing member is in the second position and including a locking member received at least partially into the respective openings.

6. The assembly as recited in claim 5, wherein the locking member comprises a rod.

7. The assembly as recited in claim 5, wherein the locking member prevents movement of the securing member from the second position.

8. The assembly as recited in claim 2, wherein the receiver has a closed periphery around the entire receiver.

9. The assembly as recited in claim 2, wherein the securing member includes a shaft that extends from a surface of the second hoistway entrance member and a head supported on the shaft distal from the surface.

10. The assembly as recited in claim 9, wherein the shaft includes a nominal outside dimension and the head includes a larger outside dimension.

11. The assembly as recited in claim 10, wherein the receiver includes an insertion portion and a securing portion, the insertion portion corresponding to the larger outside dimension and the securing portion corresponding to the nominal outside dimension.

12. The assembly as recited in claim 11, wherein the head engages a surface of the first hoistway entrance member adjacent to the securing portion.

13. The assembly as recited in claim 2, wherein the snap-fit connection comprises a bracket positioned between the first hoistway entrance member and the second hoistway entrance member.

14. The assembly as recited in claim 1, wherein the desired structural relationship includes the first hoistway entrance member transverse to the second hoistway entrance member,

15. The assembly as recited in claim 1, wherein at least one of the first hoistway entrance member or the second hoistway entrance member comprises a jamb and the other comprises a sill.

16. A method of assembling an elevator hoistway entrance comprising:
snap-fitting a first hoistway entrance member and a second hoistway entrance member together in a desired structural relation.

17. The method as recited in claim 16, including moving at least one of the first hoistway entrance member or the second hoistway entrance member in a first direction to an insertion position and moving at least one of the first hoistway entrance member or the second hoistway entrance member in a second direction to a secured position.

18. The method as recited in claim 17, including providing a securing member on one of the hoistway entrance members and a receiver on the other hoistway entrance member and at least partially inserting the securing member into the receiver when moving in the first direction.

19. The method as recited in claim 18, including maintaining the securing member at least partially within the receiver when moving in the second direction.

20. The method as recited in claim 17, including subsequently preventing the first hoistway entrance member and the second hoistway entrance member from moving from the secured position.

21. The method as recited in claim 17, wherein the first direction is transverse to the second direction.
